(19) United States
(12) Patent Application Publication
(10) Pub. No.: US 2013/0120661 A1
(43) Pub. Date: May 16, 2013

(54) PORTABLE VIDEO-AUDIO SIGNAL TRANSMITTING APPARATUS AND PORTABLE VIDEO-AUDIO SIGNAL RECEIVING APPARATUS

(71) Applicants: Ming-Dao Sie, New Taipei City (TW); Li-Tang Chang, New Taipei City (TW)

(72) Inventors: Ming-Dao Sie, New Taipei City (TW); Li-Tang Chang, New Taipei City (TW)

(73) Assignees: En Son Steel Mold CO., LTD., New Taipei City (TW); Li-Tang Chang, New Taipei City (TW)

(21) Appl. No.: 13/491,556

(22) Filed: Jun. 7, 2012

(30) Foreign Application Priority Data
Nov. 16, 2011 (TW) 100141976

(51) Int. Cl. H04N 5/38; H04N 5/268

(52) U.S. Cl. 348/705; 348/723; 348/E05.093; 348/E05.057

(57) ABSTRACT

A portable video-audio signal transmitting apparatus receiving a first video-audio signal and transmitting the first video-audio signal to a portable video-audio signal receiving apparatus includes an input module and a wireless transceiving module. The input module has a signal input circuit board and at least two signal input terminals disposed on the signal input circuit board. The first video-audio signal is transmitted to the signal input circuit board through the signal input terminals. The wireless transceiving module has a wireless transceiving circuit board, which is electrically connected to the signal input circuit board, receives the first video-audio signal and transmits a wireless signal in a wireless manner, wherein the wireless signal is received by the portable video-audio signal receiving apparatus.

### CROSS REFERENCE TO RELATED APPLICATIONS

This Non-provisional application claims priority under 35 U.S.C. §119(a) on Patent Application No(s). 100141976 filed in Taiwan, Republic of China on Nov. 16, 2011, the entire contents of which are hereby incorporated by reference.

### BACKGROUND OF THE INVENTION

1. Field of Invention

The invention relates to a video-audio transmitting apparatus, and more particularly to a portable video-audio signal transmitting apparatus and a portable video-audio signal receiving apparatus.

2. Related Art

Under the driving of the digital trend, various kinds of consumer electronic products have been regarded as important forces for pushing the growth of the market after the information products. There is no doubt that such the developing trend still continues. In addition, with the progress of the technology, the manufacturers try to integrate the richer digital video-audio contents with the higher quality into the more diversified apparatus. A multimedia apparatus, such as a multimedia computer, a multimedia video-audio player or a smart mobile phone, is a consumer electronic product that is well developed at present.

The ordinary multimedia apparatus either has no display screen or has the too-small display screen, such that the user cannot watch the multimedia film with the better video-audio quality. Thus, the user often connects the multimedia apparatus to a larger display apparatus (e.g., a liquid crystal television) with a communication cable, so that the user can watch the multimedia film on the display apparatus and enjoy the higher video-audio quality.

However, when the communication cable is adopted to couple the video-audio signal, outputted from the multimedia apparatus, to the display apparatus for display, the connection cable with the connector of the single specification has to be prepared and cannot be adapted to various types of multimedia apparatuses. In addition, if the multimedia apparatus and the display apparatus are located in different places (e.g., the multimedia computer is located in the room while the liquid crystal display apparatus is located in the living room), the connection cable has to be long enough, and the distance and the movement in use are also very inconvenient.

Therefore, it is an important subject to provide a portable video-audio signal transmitting apparatus and a portable video-audio signal receiving apparatus capable of transmitting a video-audio signal to an electronic apparatus, significantly reducing the use of a communication cable and being adapted to various kinds of connectors.

### SUMMARY OF THE INVENTION

In view of the foregoing subject, an objective of the invention is to provide a portable video-audio signal transmitting apparatus and a portable video-audio signal receiving apparatus capable of transmitting a video-audio signal to an electronic apparatus, significantly reducing the use of a communication cable and being adapted to various kinds of connectors.

To achieve the above objective, the present invention discloses a portable video-audio signal transmitting apparatus, which receives a first video-audio signal and transmits the first video-audio signal to a portable video-audio signal receiving apparatus. The portable video-audio signal transmitting apparatus includes an input module and a wireless transceiving module. The input module has a signal input circuit board and at least two signal input terminals disposed on the signal input circuit board. The first video-audio signal is transmitted to the signal input circuit board through the signal input terminals. The wireless transceiving module has a wireless transceiving circuit board, which is electrically connected to the signal input circuit board, receives the first video-audio signal and transmits a wireless signal in a wireless manner, wherein the wireless signal is received by the portable video-audio signal receiving apparatus.

In one embodiment, the signal input terminals comprise a 30-pin connector, an A-type or a C-type high-definition multimedia interface (HDMI) connector, a mini display port, a micro universal serial bus (USB) or video-audio terminals (AV terminals).

In one embodiment, the portable video-audio signal transmitting apparatus further comprises a housing, and the input module and the wireless transceiving module are disposed in the housing in an overlapped manner.

In one embodiment, the wireless transceiving module further has an antenna, which is disposed in the housing. The antenna is not exposed out of the housing, and is electrically connected to the wireless transceiving circuit board. The wireless signal is transmitted out through the antenna.

In one embodiment, a transmission frequency of the wireless transceiving module is 5.8 GHz.

In one embodiment, the portable video-audio signal transmitting apparatus further comprises a power supply element, which is disposed on the housing and supplies required electric power to the portable video-audio signal transmitting apparatus.

In one embodiment, the portable video-audio signal transmitting apparatus further comprises a selection switch electrically connected to the signal input circuit board. The first video-audio signal is selectively inputted to at least one of the signal input terminals through the selection switch.

In one embodiment, the portable video-audio signal transmitting apparatus further comprises a prompt element, which is electrically connected to the signal input circuit board, and correspondingly outputs a prompt signal according to the first video-audio signal inputted to one of the signal input terminals.

To achieve the above objective, the present invention also discloses a portable video-audio signal receiving apparatus, which receives a wireless signal and transmits the wireless signal to an electronic apparatus. The portable video-audio signal receiving apparatus comprises a wireless receiving module having at least two signal output terminals and a signal output circuit board. The signal output terminals are disposed on the signal output circuit board. The signal output circuit board receives the wireless signal in a wireless manner and outputs a second video-audio signal, which is transmitted to the electronic apparatus through the signal output terminals.

In one embodiment, the signal output terminals comprise an S/PDIF connector, video-audio terminals (AV terminals), an A-type or a C-type high-definition multimedia interface (HDMI) connector or a mini display port.

In one embodiment, the portable video-audio signal receiving apparatus further comprises a housing, in which the wireless receiving module is disposed.

In one embodiment, the wireless receiving module further has an antenna, which is electrically connected to the signal output circuit board, is disposed in the housing, and is not exposed out of the housing.

In one embodiment, the signal output circuit board receives the wireless signal through the antenna, processes the wireless signal and then outputs the second video-audio signal.

As mentioned above, the portable video-audio signal transmitting apparatus and the portable video-audio signal receiving apparatus according to the invention have at least two signal input terminals and at least two signal output terminals. In addition, the wireless transceiving module of the portable video-audio signal transmitting apparatus receives the first video-audio signal and transmits a wireless signal in a wireless manner, while the wireless receiving module of the portable video-audio signal receiving apparatus receives the wireless signal in the wireless manner and outputs a second video-audio signal to the electronic apparatus. Thus, the use of the communication cable can be significantly reduced, and the invention is adapted to various kinds of connectors and also has the convenience of use in the aspects of distance and movement.

### BRIEF DESCRIPTION OF THE DRAWINGS

The invention will become more fully understood from the detailed description and accompanying drawings, which are given for illustration only, and thus are not limitative of the present invention, and wherein:

FIGS. 1 and FIGS. 2A and 2B are respectively a functional block diagram, a top sectional view and a side sectional view of a portable video-audio signal transmitting apparatus of the invention;

FIG. 2C is a schematic illustration showing another connection between a wireless transceiving circuit board and a signal input circuit board of the portable video-audio signal transmitting apparatus of the invention;

FIGS. 3 and 4 are respectively a functional block diagram and a side sectional view of a portable video-audio signal receiving apparatus of the invention; and

FIGS. 5A and 5B are schematic illustrations showing applications of the portable video-audio signal transmitting apparatus and the portable video-audio signal receiving apparatus of the invention.

### DETAILED DESCRIPTION OF THE INVENTION

The present invention will be apparent from the following detailed description, which proceeds with reference to the accompanying drawings, wherein the same references relate to the same elements.

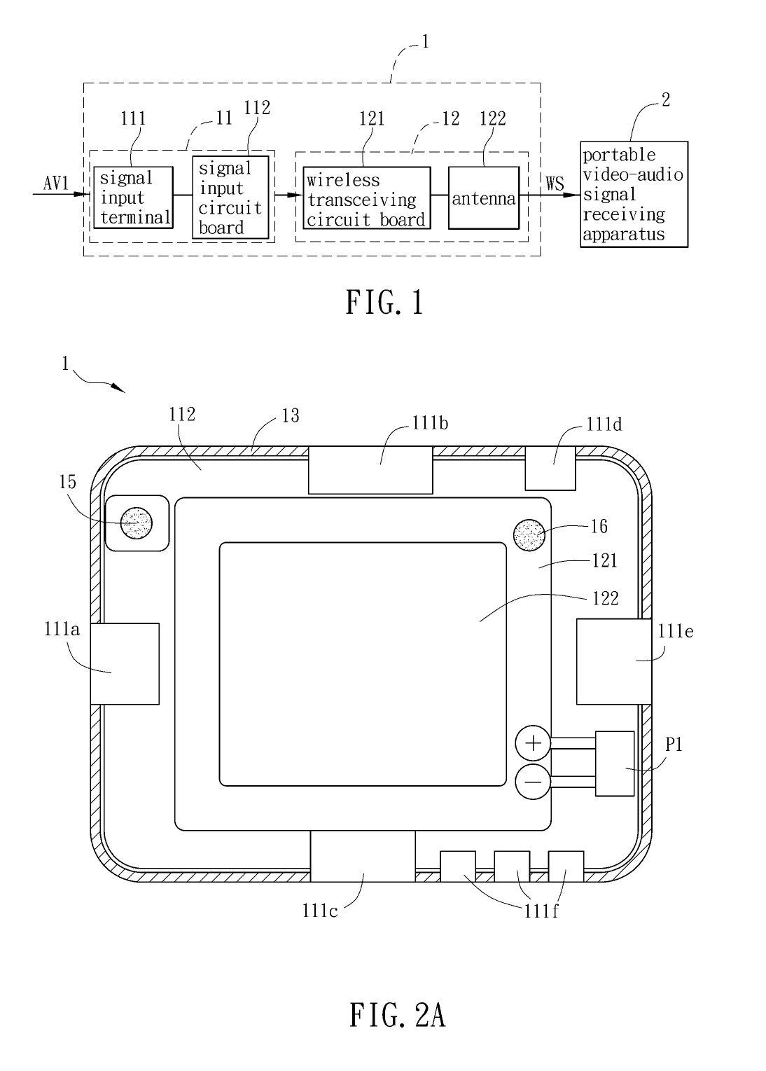

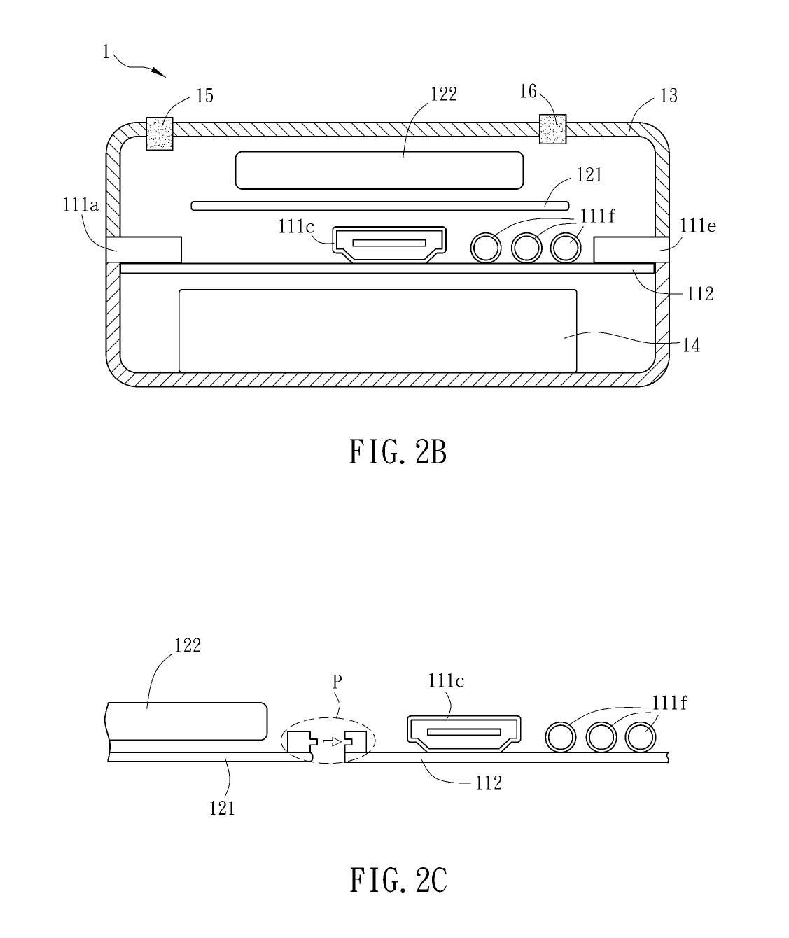

FIG. 1 and FIGS. 2A and 2B are respectively a functional block diagram, a top sectional view and a side sectional view of a portable video-audio signal transmitting apparatus 1 of the invention. Referring to FIGS. 1, 2A and 2B, a portable video-audio signal transmitting apparatus 1 of the invention can receive a first video-audio signal AV1 and transmit the first video-audio signal AV1 to a portable video-audio signal receiving apparatus 2. It is to be specified first that the source of the first video-audio signal AV1 may be, for example but without limitation to, a smart mobile phone, a multimedia computer or a multimedia player, and the first video-audio signal AV1 may be, for example but without limitation to, a video signal, an audio signal or a video-audio signal.

The portable video-audio signal transmitting apparatus 1 includes an input module 11 and a wireless transceiving module 12.

The input module 11 has at least two signal input terminals 111 (only one is shown in FIG. 1) and a signal input circuit board 112. The signal input terminals 111 are disposed on the signal input circuit board 112. The first video-audio signal AV1 inputted to the portable video-audio signal transmitting apparatus 1 is transmitted to the signal input circuit board 112 through the signal input terminals 111. The signal input terminals 111 may include, for example, a 30-pin connector (the connector of Apple Company's iPHONE), an A-type or a C-type high-definition multimedia interface (HDMI) connector (HDMI type A or C), a mini display port, a micro universal serial bus (micro USB) or video-audio terminals (AV terminal including a video terminal, a left audio terminal and a right audio terminal).

In this embodiment, as shown in FIG. 2A, the input module 11 has six different signal input terminals 111a to 111f, for example, and these signal input terminals 111a to 111f include a 30-pin connector 111a, an A-type or a C-type HDMI connector 111b or 111c, a mini display port 111d, a micro USB 111e and video-audio terminals 111f, and the first video-audio signal AV1 may be inputted to the signal input circuit board 112 through at least one of the six different signal input terminals 111a to 111f.

The wireless transceiving module 12 has a wireless transceiving circuit board 121 electrically connected to the signal input circuit board 112. The wireless transceiving circuit board 121 receives the first video-audio signal AV1, transmitted from the signal input circuit board 112, processes the first video-audio signal AV1 and then transmits a wireless signal WS in a wireless manner. The wireless signal WS is received by the portable video-audio signal receiving apparatus 2.

In addition, as shown in FIGS. 2A and 2B, the portable video-audio signal transmitting apparatus 1 may further include a housing 13, the signal input terminals 111a to 111f are disposed in the housing 13 and partially exposed out of the housing 13 so that the connection terminals transmitting the first video-audio signal AV1 can be connected to the signal input terminals 111a to 111f. In addition, the input module 11 and the wireless transceiving module 12 in this embodiment are disposed in the housing 13 and in an overlapped manner, and the wireless transceiving circuit board 121 is electrically connected to the signal input circuit board 112 through, for example, a cable (not shown) so that the portable video-audio signal transmitting apparatus 1 has the reduced size and can achieve the object of becoming a hand-held apparatus and can be moved whenever necessary, and the user can conveniently carry and use the apparatus. Nevertheless, in other embodiments, as shown in FIG. 2C, the wireless transceiving circuit board 121 and the signal input circuit board 112 may also be arranged in parallel, and are electrically connected together using, for example, a set of side-connection connectors P.

Referring again to FIG. 2B, the wireless transceiving module 12 further has an antenna 122, which is disposed in the housing 13 and is hidden and not exposed out of the housing 13. The antenna 122 is electrically connected to the wireless transceiving circuit board 121, and the wireless signal WS is transmitted out through the antenna 122. In detail, the signal input circuit board 112 receives the first video-audio signal AV1 and then transmits the first video-audio signal AV1 to the wireless transceiving circuit board 121 of the wireless transceiving module 12, which processes the first video-audio signal AV1 and then outputs the wireless signal WS. The wireless signal WS is transmitted out through the antenna 122 and then received by the portable video-audio signal receiving apparatus 2.

In addition, the portable video-audio signal transmitting apparatus 1 may further include a power supply element 14 disposed in the housing 13. The power supply element 14 can provide the required electric power to the portable video-audio signal transmitting apparatus 1 and facilitate the user in using the portable video-audio signal transmitting apparatus 1 at any time and any place without being restricted by the source of the mains. The power supply element 14 may be, for example, a rechargeable battery.

Referring to FIG. 2A, the portable video-audio signal transmitting apparatus 1 may further include a power socket P1, which is disposed in the housing 13 and electrically connected to the power supply element 14 and the signal input circuit board 112. Therefore, in addition to solely using the electric power of the power supply element 14, the portable video-audio signal transmitting apparatus 1 may also select to use electric power of the external power provided through the power socket P1. In addition, the external power can be provided to the portable video-audio signal transmitting apparatus 1 as well as to charge the power supply element 14.

In addition, the portable video-audio signal transmitting apparatus 1 may further include a selection switch 15 electrically connected to the signal input circuit board 112. The first video-audio signal AV1 is selectively inputted to at least one of the signal input terminals 111a to 111f through the selection switch 15. In response to different input connectors of the first video-audio signal AV1, it is possible to select at least one of the signal input terminals 111a to 111f to be connected to the input connector of the first video-audio signal AV1 through the selection of the selection switch 15. In addition to selecting the signal source of the input terminal through the selection switch 15, the portable video-audio signal transmitting apparatus 1 may also make an automatic judgment according to the priority that the signal input terminals 111a to 111f are inputted by the signal source in other embodiments, so that the signal source of the first video-audio signal AV1 can be automatically selected.

In addition, the portable video-audio signal transmitting apparatus 1 may further include a prompt element 16, which is electrically connected to the signal input circuit board 112 and correspondingly outputs a prompt signal according to the first video-audio signal AV1 inputted to one of the signal input terminals 111a to 111f. In other words, the user may know that the first video-audio signal AV1 is inputted to which one of the signal input terminals 111a to 111f through the prompt signal. The prompt signal may be, for example but without limitation to, a lamp light signal and/or an audio signal, such as the light outputted from a light-emitting diode (LED) and/or an audio prompt.

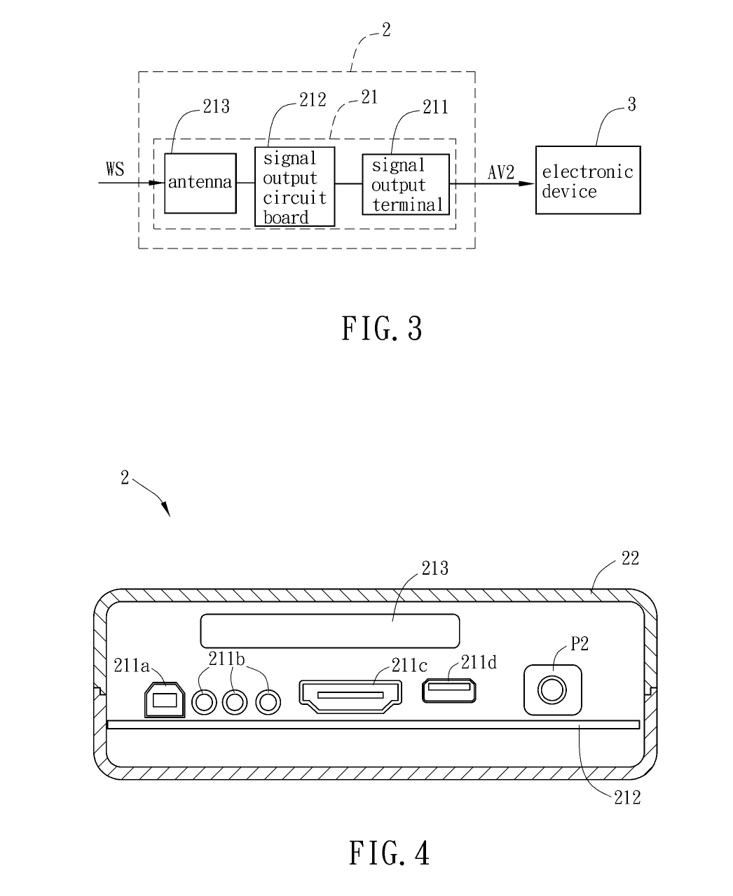

FIGS. 3 and 4 are respectively a functional block diagram and a side sectional view of a portable video-audio signal receiving apparatus 2 of the invention. As shown in FIGS. 3 and 4, the portable video-audio signal receiving apparatus 2 of the invention may receive the wireless signal WS, and transmits the wireless signal WS to an electronic apparatus 3. It is to be specified first that the source of the wireless signal WS is outputted from the portable video-audio signal transmitting apparatus 1 of the invention. In addition, the electronic apparatus 3 may be a multimedia or display apparatus, such as but without limitation to, a television, a multimedia computer, a video-audio player, a projector, a smart mobile phone or the like.

The portable video-audio signal receiving apparatus 2 includes a wireless receiving module 21 and a housing 22, and the wireless receiving module 21 is disposed in the housing 22.

The wireless receiving module 21 has at least two signal output terminals 211 (only one is shown in FIG. 4) and a signal output circuit board 212, and the signal output terminals 211 are disposed on the signal output circuit board 212. In addition, the signal output circuit board 212 receives the wireless signal WS in a wireless manner, and outputs a second video-audio signal AV2, which is transmitted to the electronic apparatus 3 through the signal output terminals 211. The second video-audio signal AV2 may be, for example but without limitation to, a video signal, an audio signal, a video-audio signal or the like.

The signal output terminals 211 are electrically connected to the signal output circuit board 212, are partially exposed out of the housing 22 and output the second video-audio signal AV2 to the electronic apparatus 3. The signal output terminals 211 may include, for example, an S/PDIF connector, a video-audio terminal (AV terminal), an A-type HDMI connector (HDMI type A) or a mini display port. In this example embodiment to be described, as shown in FIG. 4, the signal output terminals 211 have four different signal input terminals 211a to 211d, which are disposed on the same side of the housing 22. These signal input terminals 211a to 211d include a S/PDIF connector 211a, a video-audio terminal 211b, an A-type HDMI connector 211c and a mini display port 211d, and the second video-audio signal AV2 may be transmitted to the electronic apparatus 3 through at least one of the four different signal output terminals 211a to 211d.

In addition, the wireless receiving module 21 may further have an antenna 213 electrically connected to the signal output circuit board 212. The antenna 213 is disposed in the housing 22 and is hidden and not exposed out of the housing 22. In addition, the antenna 213 is electrically connected to the signal output circuit board 212, and the wireless signal WS is received through the antenna 122. In detail, the wireless signal WS transmitted by the portable video-audio signal transmitting apparatus 1 is received through the antenna 213, and then transmitted to the signal output circuit board 212 of the wireless receiving module 21, which processes the wireless signal WS into the second video-audio signal AV2, and outputs the second video-audio signal AV2 to the electronic apparatus 3 through at least one of the signal output terminals 211a to 211d.

Furthermore, the portable video-audio signal receiving apparatus 2 may further include a power supply element (not shown) disposed in the housing 22. The power supply element can provide the required electric power to the portable video-audio signal receiving apparatus 2 to facilitate the user in using the portable video-audio signal receiving apparatus 2 at any time and any place without being restricted by the source of the mains. The power supply element may be, for example, a rechargeable battery.

In addition, referring to FIG. 4, the portable video-audio signal receiving apparatus 2 may further include a power socket P2, which is disposed in the housing 22 and electrically connected to the power supply element. Therefore, in addition to solely using the electric power of the power supply element, the portable video-audio signal receiving apparatus 2 may also select to use electric power of the external power provided through the power socket P2. In addition, the external power can be provided to the portable video-audio signal receiving apparatus 2 as well as to charge the power supply element.

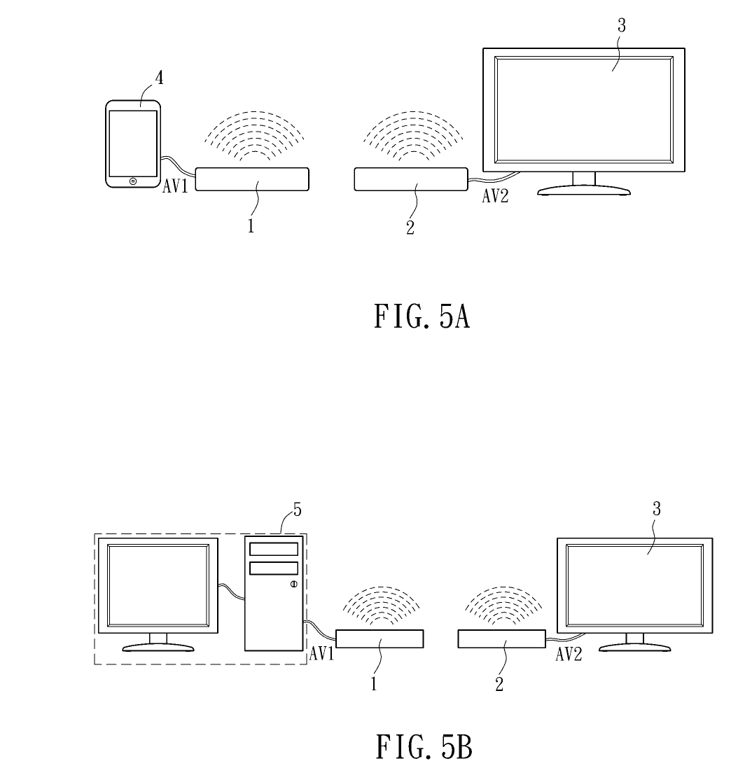

FIGS. 5A and 5B are schematic illustrations showing applications of the portable video-audio signal transmitting apparatus 1 and the portable video-audio signal receiving apparatus 2 of the invention.

As shown in FIG. 5A, the first video-audio signal AV1 is generated by a smart mobile phone 4 and transmitted to the portable video-audio signal transmitting apparatus 1, and then transmitted by the portable video-audio signal transmitting apparatus 1 in a wireless manner and received by the portable video-audio signal receiving apparatus 2, which outputs the second video-audio signal AV2 to a display apparatus 3 for display.

As shown in FIG. 5B, the first video-audio signal AV1 is generated by a multimedia computer 5, transmitted to the portable video-audio signal transmitting apparatus 1, and then transmitted by the portable video-audio signal transmitting apparatus 1 in a wireless manner and received by the portable video-audio signal receiving apparatus 2, which outputs the second video-audio signal AV2 to the display apparatus 3 for display.

Finally, it is to be specified that the portable video-audio signal transmitting apparatus 1 and the portable video-audio signal receiving apparatus 2 of the invention adopt the wireless multimedia transmission technology (wireless home digital interface, WHDI) to transmit the video-audio signal, and can transmit the high-definition video, such as the video signal of HD 1080P. In addition, the wireless transmission frequency may be, for example but without limitation to, 5.8 G Hz (5.8×10⁹ Hz). In addition, the invention adopts the peer-to-peer (P2P) technology to transmit the wireless signal. The P2P technology has the advantages of withstanding the attack and the high fault-tolerant, so the transmission of the wireless signal WS becomes more stable and reliable.

In summary, the portable video-audio signal transmitting apparatus and the portable video-audio signal receiving apparatus according to the invention have at least two signal input terminals and at least two signal output terminals. In addition, the wireless transceiving module of the portable video-audio signal transmitting apparatus receives the first video-audio signal and transmits a wireless signal in a wireless manner, while the wireless receiving module of the portable video-audio signal receiving apparatus receives the wireless signal in the wireless manner and outputs a second video-audio signal to the electronic apparatus. Thus, the use of the communication cable can be significantly reduced, and the invention is adapted to various kinds of connectors and also has the convenience of use in the aspects of distance and movement.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A portable video-audio signal transmitting apparatus, which receives a first video-audio signal and transmits the first video-audio signal to a portable video-audio signal receiving apparatus, the portable video-audio signal transmitting apparatus comprising:
an input module having at least two signal input terminals and a signal input circuit board, wherein the signal input terminals are disposed on the signal input circuit board, and the first video-audio signal is transmitted to the signal input circuit board through the signal input terminals; and
a wireless transceiving module having a wireless transceiving circuit board electrically connected to the signal input circuit board, wherein the wireless transceiving circuit board receives the first video-audio signal and transmits a wireless signal in a wireless manner, and the wireless signal is received by the portable video-audio signal receiving apparatus.

2. The portable video-audio signal transmitting apparatus according to claim 1, wherein the signal input terminals comprise a 30-pin connector, an A-type or a C-type high-definition multimedia interface (HDMI) connector, a mini display port, a micro universal serial bus (USB) or video-audio terminals (AV terminals).

3. The portable video-audio signal transmitting apparatus according to claim 1, further comprising:
a housing, wherein the input module and the wireless transceiving module are disposed in the housing in an overlapped manner.

4. The portable video-audio signal transmitting apparatus according to claim 3, wherein the wireless transceiving module further has an antenna, which is disposed in the housing, is not exposed out of the housing, and is electrically connected to the wireless transceiving circuit board, and the wireless signal is transmitted out through the antenna.

5. The portable video-audio signal transmitting apparatus according to claim 3, further comprising:
a power supply element, which is disposed on the housing and supplies required electric power to the portable video-audio signal transmitting apparatus.

6. The portable video-audio signal transmitting apparatus according to claim 1, wherein a transmission frequency of the wireless transceiving module is 5.8G Hz.

7. The portable video-audio signal transmitting apparatus according to claim 1, further comprising:
a selection switch electrically connected to the signal input circuit board, wherein the first video-audio signal is selectively inputted to at least one of the signal input terminals through the selection switch.

8. The portable video-audio signal transmitting apparatus according to claim 1, further comprising:
a prompt element, which is electrically connected to the signal input circuit board, and correspondingly outputs a prompt signal according to the first video-audio signal inputted to one of the signal input terminals.

9. A portable video-audio signal receiving apparatus, which receives a wireless signal and transmits the wireless signal to an electronic apparatus, the portable video-audio signal receiving apparatus comprising:
a wireless receiving module having at least two signal output terminals and a signal output circuit board, wherein the signal output terminals are disposed on the signal output circuit board, and the signal output circuit board receives the wireless signal in a wireless manner and outputs a second video-audio signal, which is transmitted to the electronic apparatus through the signal output terminals.

10. The portable video-audio signal receiving apparatus according to claim 9, wherein the signal output terminals comprise an S/PDIF connector, video-audio terminals (AV terminals), an A-type or a C-type high-definition multimedia interface (HDMI) connector or a mini display port.

11. The portable video-audio signal receiving apparatus according to claim 9, further comprising:
a housing, in which the wireless receiving module is disposed.

12. The portable video-audio signal receiving apparatus according to claim 11, wherein the wireless receiving module further has an antenna, which is electrically connected to the signal output circuit board, is disposed in the housing, and is not exposed out of the housing.

13. The portable video-audio signal receiving apparatus according to claim 12, wherein the signal output circuit board receives the wireless signal through the antenna, processes the wireless signal and then outputs the second video-audio signal.
